(19) United States
(12) Patent Application Publication
(10) Pub. No.: US 2026/0087262 A1
(43) Pub. Date: Mar. 26, 2026

(54) SYSTEMS AND METHODS FOR USING LARGE LANGUAGE MODELS TO GENERATE WORKFORCE-SPECIFIC INSIGHTS

(71) Applicant: Cangrade, Inc., Watertown, MA (US)

(72) Inventors: Katherine CHIA, Watertown, MA (US); Gershon GOREN, Watertown, MA (US)

(21) Appl. No.: 19/336,929

(22) Filed: Sep. 23, 2025

Related U.S. Application Data
(60) Provisional application No. 63/697,791, filed on Sep. 23, 2024.

(51) Int. Cl. G06F 40/35; G06Q 10/0637

(52) U.S. Cl. CPC G06F 40/35; G06Q 10/0637

(57) ABSTRACT

A computing device can receive an input associated with a user account. The computing device can perform a comparison of the input to one or more predefined input criteria. In response to the comparison, the computing device can determine a response module from one or more response modules based on the user account. The computing device can determine a context associated with the input based on the response module. The computing device can generate a prompt comprising the context and the input. The computing device can apply a large language model to the prompt to generate an output and transmit the output to the user account.

### CROSS-REFERENCE TO RELATED APPLICATIONS

This application is a non-provisional application claiming the benefit of and priority to U.S. Provisional Application No. 63/697,791, filed on Sep. 23, 2024, entitled SYSTEMS AND METHODS FOR USING LARGE LANGUAGE MODELS TO GENERATE WORKFORCE-SPECIFIC INSIGHTS, the entirety of which is incorporated here by reference.

### TECHNICAL FIELD

This application generally relates to systems and methods for generating personality and context-specific insights and, more specifically, to using one or more large language models to generate context and personality-specific responses for one or more individuals interacting in a workforce-specific environment.

### BACKGROUND

Managing employees, administrators, or anyone who partakes in the workforce has always been a demanding and important aspect of a functional institution. Motivating employees, formulating plans for projects, and generating other workforce-specific practices are of increased value to corporations trying to maximize their employee's happiness, efficiency, and abilities. Furthermore, individuals outside of the workforce constantly search for valuable insights that could help improve their abilities. To this date, there are no known systems or methods that generate information to augment an institution's ability to manage individuals.

Moreover, there are no known systems or methods that generate information to augment an individual user's abilities. Therefore, there is a long-felt but unresolved need for a system or method that can generate workforce-specific insights to support and/or augment one or more characteristics of an individual's abilities.

### BRIEF SUMMARY OF DISCLOSURE

Briefly described, and in various examples, the present disclosure relates to systems and methods for generating through one or more large language models context and/or personality-specific responses for workforce-related inquiries. The disclosed technology can include a computing environment that can optimize workplace interactions by providing contextually relevant, personality-informed responses to workforce-related inquiries. The disclosed technology, which can be used by recruiters, hiring managers, employees, candidates, and anyone else, can generate responses that can enhance decision-making, analyze workspace-related situations, provide resolutions, foster professional development, augment self-reflection, and answer general queries, among other uses, by analyzing user inputs and generating personalized advice based on personality insights. The disclosed technology can include systems and methods that generate user-related insights to inputs that do not include workplace-related questions. For example, the disclosed technology can include one or more large language models capable of generating personality-specific responses to individuals requesting information and/or insights on a particular scenario. In some examples, the particular scenario can include workspace-related information and in other examples, the particular scenario can include non-workspace-related information (e.g., a request for information on particular educational practices for a particular student).

The computing environment can employ several techniques to interpret user inputs. For example, the computing environment can categorize inputs into specific workplace scenarios such as but not limited to employee feedback, performance discussions, or management strategies. The computing environment can include detailed personality profiles. The computing environment using the detailed personality profiles can identify key traits that influence behavior and decision-making. By identifying the key traits, the disclosed system can deliver responses that are not generic but customized to the unique characteristics of the user or the user in question.

The disclosed system can analyze user inputs to determine the specific scenario being addressed and enable scenario-appropriate guidance. The disclosed system can utilize personality traits to tailor responses. For example, the disclosed technology can provide advice that aligns with the behavioral tendencies and characteristics of the people involved. The disclosed system can align advice with the identified personality traits to help users make informed decisions, manage interpersonal situations, develop professionalism, perform self-reflection, resolve conflicts, and enhance the workplace experience. The disclosed system can use one or more large language models to generate any particular output discussed herein.

The disclosed technology can include various systems. For example, the disclosed technology can include a business-general system, a business-role system, and a self-discovery system. The business-general system can utilize one or more identified traits of an individual in question (e.g., an employee, manager, recruiter, job candidate, job seeker, or anyone) to generate a particular response. For example, the business-general system can receive an input asking for business-related advice for the particular individual in question. The business-general system can provide an output that details guidance or feedback that is specific to the individual in question based on the particular input and/or any of the identified traits of the individual in question. The business-role system can generate a response similar to the business-general system while incorporating information that is specific to a particular job role. For example, the business-role system can employ the identified traits of the individual in question to generate a response that details if the identified traits are advantageous or disadvantageous for the particular job role. The self-discovery system can generate responses for an individual who seeks to uncover insights about themselves or otherwise seek guidance or advice on their situations. This variation is not limited to business situations or contexts. For example, the self-discovery role, using known traits of the particular individual, can generate recommendations for amplifying work experiences on a resume. The self-discovery system can use any particular data of the particular user to generate user-specific advice for any scenario described in the input. The self-discovery system can function independently from the business-general system and the business-role system. The self-discovery system can be used by any particular user looking to gain personal insights into their particular scenario.

These and other aspects, features, and benefits of the claimed innovation(s) will become apparent from the following detailed written description of the preferred examples and aspects taken in conjunction with the following drawings, although variations and modifications thereto may be effected without departing from the spirit and scope of the novel concepts of the disclosure.

### BRIEF DESCRIPTION OF THE FIGURES

The accompanying drawings illustrate one or more examples and/or aspects of the disclosure and, together with the written description, serve to explain the principles of the disclosure. Wherever possible, the same reference numbers are used throughout the drawings to refer to the same or like elements of the present concept, and wherein:

FIG. 1 illustrates an example communication, according to one example of the disclosed technology;

FIG. 2 illustrates an example networked environment, according to one example of the disclosed technology;

FIG. 3 illustrates an example flowchart of a first process, according to one example of the disclosed technology; and

FIG. 4 illustrates an example flowchart of a second process, according to one example of the disclosed technology.

### DETAILED DESCRIPTION

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

For the purpose of promoting an understanding of the principles of the present disclosure, reference will now be made to the examples illustrated in the drawings and specific language will be used to describe the same. It will, nevertheless, be understood that no limitation of the scope of the disclosure is thereby intended; any alterations and further modifications of the described or illustrated examples and any further applications of the principles of the disclosure as illustrated therein are contemplated as would normally occur to one skilled in the art to which the disclosure relates. All limitations of scope should be determined in accordance with and as expressed in the claims.

### Example Embodiments

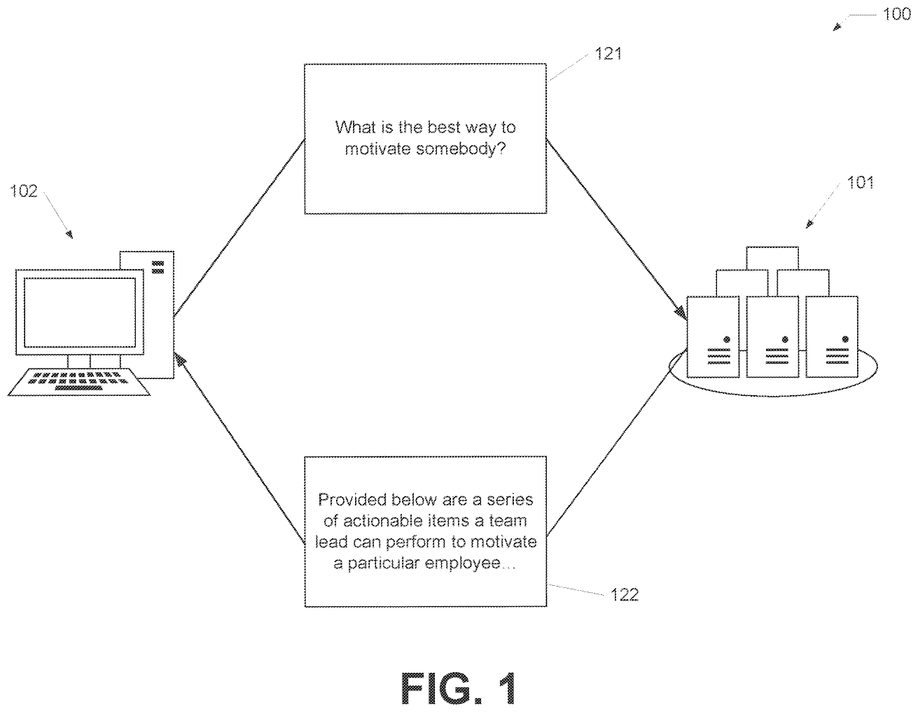

Referring now to the figures, for the purposes of example and explanation of the fundamental processes and components of the disclosed apparatuses, systems, and methods, reference is made to FIG. 1, which illustrates an example communication 100. As will be understood and appreciated, the communication 100 shown in FIG. 1 represents merely one approach or example of the present concept, and other aspects are used according to various examples of the present concept.

The communication 100 can illustrate a scenario where a user, such as a manager, an HR employee, a company employee, a job candidate, any particular individual associated with an entity, or anyone in general has a workforce-related question and would like a context and/or personality-specific response based on the particular question. The communication 100 can include one or more inputs 121 and one or more outputs 123 sent between a user device 102 and a computing environment 101. The computing environment 101 can include one or more large language models capable of generating the outputs 123 based on the inputs 121, user-specific information, context-specific information, and/or any other pertinent information associated with the workforce-related question. For example, the communication 100 can define a particular scenario where a user of the user device 102 can send the input 121 to the computing environment 101. The computing environment 101 on receiving the particular input 121 can employ one or more large language models to generate the output 123 based on stored data and the input 121.

The input 121 can include any particular request for advice and/or information that pertains to a workforce-related scenario and/or a specific individual. For example, the input 121 can include a first request that states, “What is the best way to motivate somebody?” The computing environment 101 can employ the large language model to process the input 121 to generate the output 123. For example, on receiving the first request, the computing environment 101 can prompt the large language model to identify if the first request has any inappropriate and/or sensitive information. On determining that the first request does not have any inappropriate and/or sensitive information, the computing environment 101 can prompt the large language model to generate a response to the first request based on a subset of data. The subset of data can include pertinent information about general business practices, general workplace psychology theories, and/or any particular information that relates to workplace environments and procedures. Based on the context of the subset of data, the large language model of the computing environment 101 can generate a context-specific response to the first request. For example, the computing environment 101 can generate the output 123 that includes a first response, which can state the various known theories that have been successful in motivating employees and/or individuals to perform at a higher level.

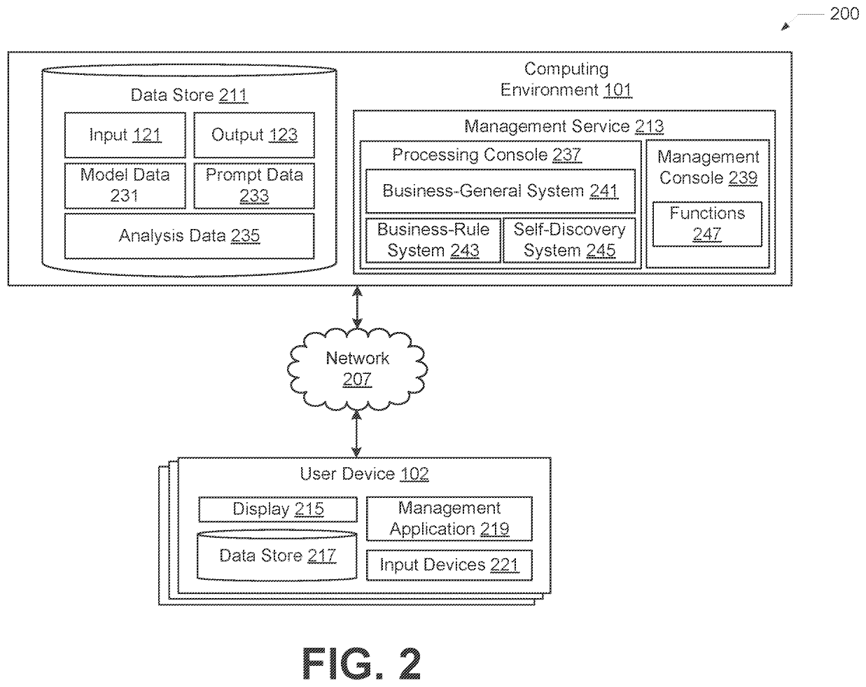

As discussed in further detail herein, the computing environment 101 can include various systems for generating different types of workspace-specific information. For example, the computing environment 101 can include a business-general system 241, a business-role system 243, and a self-discovery system 245 (see FIG. 2 for further details). The business-general system 241 can utilize one or more identified traits of an individual in question (e.g., an employee, manager, recruiter, job candidate, job seeker, or anyone) to generate the output 123 to the input 121. For example, the business-general system 241 can receive a particular input 121 asking for business-related advice for the particular individual in question. The business-general system 241 can provide a particular output 123 that details guidance or feedback that is specific to the individual in question based on the particular input 121 and/or any of the identified traits of the individual in question. The business-role system 243 can generate a response similar to the business-general system 241 while incorporating information that is specific to a particular job role. For example, the business-role system 243 can employ the identified traits of the individual in question to generate a particular output 123 that details if the identified traits of the individual in question are advantageous or disadvantageous for the particular job role. The self-discovery system 245 can generate a particular output 123 for an individual who seeks to uncover insights about themselves or otherwise seek guidance or advice on their situations. This variation is not limited to business situations or contexts. For example, the self-discovery system 245, using known traits of the particular individual, can generate recommendations for amplifying work experiences on a resume. The self-discovery system 245 can use any particular data of the particular user to generate user-specific advice for any scenario described in a particular input 121. The business-general system 241, the business-role system 243, and the self-discovery system 245 can include a response module or can be collectively referred to as a response module.

Referring now to FIG. 2, illustrated is an example networked environment 200, according to one example of the disclosed technology. The networked environment 200 can include a computing environment 101 and a user device 102, which can be in data communication with each other via a network 207. The network 207 can include, for example, the Internet, intranets, extranets, wide area networks (WANs), local area networks (LANs), wired networks, wireless networks, or other suitable networks, etc., or any combination of two or more such networks. For example, such networks can include satellite networks, cable networks, Ethernet networks, Bluetooth networks, Wi-Fi networks, NFC networks, and other types of networks.

The computing environment 101 can include, for example, a server computer or any other system providing computing capability. Alternatively, the computing environment 101 can employ more than one computing devices that can be arranged, for example, in one or more server banks or computer banks or other arrangements. Such computing devices can be located in a single installation or can be distributed among many different geographical locations. For example, the computing environment 101 can include one or more computing devices that together can include a hosted computing resource, a grid computing resource and/or any other distributed computing arrangement. In some cases, the computing environment 101 can correspond to an elastic computing resource where the allotted capacity of processing, network, storage, or other computing-related resources can vary over time.

The data stored in the data store 211 can include, for example, list of data, and potentially other data. For example, the data store 211 can include one or more inputs 121, one or more outputs 123, model data 231, prompt data 233, and analysis data 235. The data store 211 can function as the central data storage system of the networked environment 200. The data store 211 can be distributed across various locations and/or located in a single location.

The input 121 can include any inputs received by the computing environment 101 from the one or more user devices 102. The inputs 121 can include various forms of requests for information, advice, plans, and/or any pertinent workforce-related inquiry. For example, the input 121 can include a request for tips on how to increase the productivity of a product manager. In another example, the input 121 can include a request for bonding activities a HR department can use to increase the cooperation between employees. In yet another example, the input 121 can include a request, specific to a particular individual, on how to increase the particular individual's productivity in their specific job role. The inputs 121 can be associated with a particular user device 102 and/or a user account. The inputs 121 can be aggregated and stored such that conversations can be monitored and used in future scenarios. For example, one or more inputs 121 sent by the same user device 102 can be aggregated and stored as one or more conversations. Continuing this example, the computing environment 101 can index prior conversations and inputs 121 to see if similar questions and/or requests have been made in the past.

The output 123 can include any particular output generated by the computing environment 101. The output 123 can include any particular response generated by the computing environment 101 in response to the input 121. The output 123, for example, can include a list of proposed bonding activities. In another example, the output 123 can include a list of techniques that an employer can use to motivate a product manager. In yet another example, the output 123 can include person-specific, context-specific, and/or job role specific responses to a particular input 121. The output 123 can be stored and associated with the particular input 121. The output 123 can be associated with a particular user device 102 and/or the user account.

The model data 231 can include any information used to process, train, and implement machine learning models/algorithms, artificially intelligent systems, deep learning models (e.g., neural networks), large language models, and/or natural language processing systems. Non-limiting examples of models stored in the model data 231 can include topic modelers, neural networks, linear regression, logistic regression, ordinary least squares regression, stepwise regression, multivariate adaptive regression splines, ridge regression, least-angle regression, locally estimated scatterplot smoothing, decision trees, random forest classification, support vector machines, Bayesian algorithms, hierarchical clustering, k-nearest neighbors, K-means, expectation maximization, association rule learning algorithms, learning vector quantization, self-organizing map, locally weighted learning, least absolute shrinkage and selection operator, elastic net, feature selection, computer vision, dimensionality reduction algorithms, gradient boosting algorithms, and combinations thereof. Neural networks can include but are not limited to uni-or multilayer perceptron, convolutional neural networks, recurrent neural networks, long short-term memory networks, auto-encoders, deep Boltzmann machines, deep belief networks, back-propagations, stochastic gradient descents, Hopfield networks, and radial basis function networks. The model data 231 can include a plurality of models stored in the model data 231 of varying or similar composition or function.

The models stored in the model data 231 can include various properties that can be adjusted and optimized by the corresponding engine during model training. The properties can include any parameter, hyperparameter, configuration, or setting of the model stored in the model data 231. Non-limiting examples of properties include coefficients or weights of linear and logistic regression models, weights and biases of neural network-type models, cluster centroids in clustering-type models, train-test split ratio, learning rate (e.g. gradient descent), choice of optimization algorithm (e.g., gradient descent, gradient boosting, stochastic gradient descent, Adam optimizer, XGBoost, etc.), choice of activation function in a neural network layer (e.g. Sigmoid, ReLU, Tanh, etc.), choice of value or loss function, number of hidden layers in a neural network, number of activation units (e.g., artificial neurons) in each layer of a neural network, drop-out rate in a neural network (e.g., dropout probability), number of iterations (epochs) in training a neural network, number of clusters in a clustering task, Kernel or filter size in convolutional layers, pooling size, and batch size.

The model data 231 can include models, data, and/or any other information employed by the computing environment 101. For example, the model data 231 can include one or more large language models used to generate the outputs 123 based on the inputs 121. For example, the model data 231 can include access to GPT-3, GPT-3.5, GPT-4, GPT-4o, Gemini, BERT, and/or any other particular large language model. The model data 231 can include various API interfaces for interfacing with the one or more large language models.

The prompt data 233 can include one or more prompts used to prompt the large language models of the model data 231 to perform particular actions. For example, the prompt can be defined as various rules and requirements the large language model can follow for generating the output. The prompt data 233 can include, for example, a request to monitor the inputs 121 for any sensitive and/or inappropriate information. In another example, the prompt data 233 can detail the documents that the large language model can use to generate the output 123. In yet another example, the prompt data 233 can include a request to remove any sensitive information from the output 123. The prompt data 233 can include any particular parameters employed by the large language model for generating the outputs 123. The prompt data 233 can be organized into particular categories for particular use case scenarios. The computing environment 101 can employ one or more prompts from distinct categories to prompt the large language model to perform a particular action.

The analysis data 235 can include any particular data used by the large language models to generate the output 123. For example, the analysis data 235 can include but is not limited to, employee profiles, company profiles, job role descriptions, scholarly data on workplace-related topics, and/or any other particular information that can be used to generate personality-specific and/or context-specific responses to a particular input 121. For example, the analysis data 235 can include one or more studies that detail techniques for motivating employees. In another example, the analysis data 235 can include one or more performance reviews for a particular individual. In yet another example, the analysis data 235 can include various resumes of individuals applying to a particular job position.

Various applications and/or other functionalities can be executed in the computing environment 101 according to various embodiments. Also, various data can be stored in a data store 211 that can be accessible to the computing environment 101. The data store 211 can be representative of one or more of data stores 211 as can be appreciated. The data stored in the data store 211, for example, can be associated with the operation of the various applications and/or functional entities described below.

The computing environment 101 can include a management service 213. The management service 213 can include a processing console 237 and a management console 239. The management service 213 can include various functions, applications, and/or systems that can perform the various computational functionalities of the computing environment 101.

The management console 239 can perform various data processing and distribution for the computing environment 101. For example, the management console 239 can distribute data from the computing environment 101 to any other particular resource distributed across the network 207. In another example, the management console 239 can organize data within the computing environment 101, distribute data amongst various components of the computing environment 101, and/or perform any particular data distribution need for the computing environment 101.

The management console 239 can include one or more functions 247. The one or more functions 247 can include various applications and/or techniques that are employed by the computing environment 101 to perform particular actions. For example, the functions 247 can include one or more techniques that can assess the relevance and appropriateness of inputs 121, monitor interaction frequency, and summarize conversations to optimize the performance of the computing environment 101. The functions 247 can include an appropriateness checker and an interaction counter and summarizer. The functions 247 can be triggered at any particular moment. For example, the appropriateness checker and the interaction counter and summarizer can be employed by the management console 239 on receiving the input 121 and prior to generating the output 123.

The appropriateness checker can include a technique for evaluating the appropriateness of a particular input 121 in a professional setting. For example, the appropriateness checker can include a prompt stored in the prompt data 233 that requests the large language model to evaluate the input 121 for information such as but not limited to personal relationships, sexual content, offensive language, and other objects deemed unprofessional or irrelevant to workplace settings. The management console 239 can trigger the appropriateness checker when receiving the input 121 from the user device 102. On processing the input 121, the management console 239 can categorize the input 121 as “appropriate” or “inappropriate” for a workplace setting. Upon detection of inappropriate user input, the management console 239 can generate a predefined response that discourages unprofessional queries and encourages redirection toward workplace-appropriate topics. If the user input is appropriate as determined by the large language model, the management console 239 can feed the input 121 to other functions 247 and/or the processing console 237.

The interaction counter and summarizer can define a technique for summarizing a conversation between the user device 102 and the computing environment 101 (e.g., various inputs 121 and outputs 123 sent between the user device 102 and the computing environment 101). The interaction counter and summarizer can reduce the amount of data processed as the conversation between the user device 102 and the computing environment 101 increases in length. For example, the interaction counter and summarizer can monitor and count the interactions (e.g., inputs 121 and/or outputs 123), each of which can be categorized into predefined types. Upon reaching a predefined threshold, the management console 239 can trigger a summarization function of the interaction counter and summarizer to distill the conversation history between the user device 102 and the computing environment 101. The interaction counter and summarizer can enhance conversational flow and maintain system efficiency.

The interaction counter and summarizer can include a monitoring component that can evaluate the inputs 121 against predefined categories. When an input 121 is identified within these categories, the interaction counter and summarizer can increment a counter score by a defined increment value. The interaction counter and summarizer can evaluate the counter score against the predefined threshold value. If the counter score reaches or exceeds this threshold, the interaction counter and summarizer can activate the summarization function to distill the conversation between the user device 102 and the computing environment 101. For example, when activated, the summarization function (e.g., a large language model prompted to summarize a particular input) can process the conversation history to generate a concise summary. This summary focuses on capturing responses exchanged during the interactions and is constrained to a specific word limit. After summarization, the interaction counter and summarizer can reset the conversation to only include the summary. The interaction counter and summarizer can reset the counter score.

The processing console 237 can function as the central computing system of the computing environment 101. The processing console 237 can process data, analyze inputs 121, generate outputs 123, generate prompts, and/or perform any particular computational requirement of the computing environment 101. The processing console 237 can include a business-general system 241, a business-role system 243, and a self-discovery system 245. Each of the different systems of the processing console 237 can generate different types of outputs 123 based on the particular input 121 received from the user device 102. The processing console 237 can employ one or more models from the model data 231 to process the inputs 121 and/or generate the outputs 123. As will be understood, the processing console 237 can determine if the business-general system 241, the business-role system 243, or the self-discovery system 245 can generate the outputs 123 based on a user account and/or the inputs 121 (e.g., one or more inputs selecting the business-general system 241, the business-role system 243, or the self-discovery system 245 to generate the outputs).

The business-general system 241 can generate responses to inputs 121 based on stored personality data associated with a particular individual of interest. For example, the business-general system 241 can employ personality data to answer questions detailed in the inputs 121 sent by the user device 102. The input 121 can include information regarding the candidates' or employees' soft skills, motivations, and approaches to work. The business-general system 241 can employ a large language model from the model data 233 to generate a outputs 123 that details feedback on how to manage the particular individual. For example, the business-general system 241 can provide situational simulations to glean how the individuals in question may respond to specific professional situations. In another example, the business-general system 241 can problem-solve professional situations based on individual data and provide actionable steps and tips for resolutions. In yet another example, the business-general system 241 can determine individual upskill needs, how to motivate the individual, how to engage and retain their workforce, and how to optimize performance and improve retention. The business-general system 241 can provide the aforementioned advice based on data stored in the data store 211 and/or the input 121. The business-general system 241 can employ a large language model to generate the outputs 123 that answer the particular input 121 using the trait level data stored in the analysis data 235 of the employee or person in question.

The business-role system 243 can function substantially similarly to the business-general system 241. For example, the business-role system 243 can employ personality-related data to generate one or more workspace-related responses to a particular input 121 that requests information specific to a particular job role. For example, while the business-general system 241 generates personality and context-specific responses to inputs 121, the business-role system 243 generates personality and context-specific responses to inputs 121 as they pertain to a particular job role.

The self-discovery system 245 can function as a response generator for individuals seeking personal advice on their current situation. The self-discovery system 245 can employ the large language models to process inputs 121 and generate responses that are intended to provide workplace-related information to the individual in question. For example, the self-discover system 245 can function as a self-reflection tool. The self-discovery system 245 can enhance workplace self-awareness and development through personalized guidance based on personality traits. The self-discovery system 245 can be used in professional or personal settings, where the individual can send an input 121 through the user device 102 to seek insights on how their personalities impact their workplace behaviors and interactions, how they can develop professionally, and how to navigate particular situations.

The user device 102 can be representative of a one or more client devices that can be coupled to the network 207. The user device 102 can include, for example, a processor-based system such as a computer system. Such a computer system can be embodied in the form of a desktop computer, a laptop computer, personal digital assistants, cellular telephones, smartphones, set-top boxes, music players, web pads, tablet computer systems, game consoles, electronic book readers, or other devices with like capability. The user device 102 can include a display 215. The display 215 can include, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The user device 102 can be configured to execute various applications such as a management application 219 and/or other applications. The management application 219 can be executed in the user device 102, for example, to access network content served up by the computing environment 101 and/or other servers, thereby rendering a user interface on the display 215. To this end, the management application 219 can include, for example, a browser, a dedicated application, etc., and the user interface can include a network page, an application screen, etc. The user device 102 can execute applications beyond the management application 219 such as, for example, email applications, social networking applications, word processors, spreadsheets, and/or other applications. The management application 219 can receive inputs 121 through one or more input devices 221. For example, the input devices 221 can include a keyboard, a mouse, a data port, a microphone, a camera, and/or any other particular input peripheral. Continuing this example, the user device 102 can receive the input 121 through the input device 221. The management application 219 can render, for example, a chat box, where the input 121 is provided. On completion of the input 121 (e.g., a written request for workforce-related advice), the management application 219 can interface with the computing environment 101 and send the input 121 to the computing environment 101. The computing environment 101 can generate the output 123 based on the input 121 and return the output 123 to the management application 219. The management application 219 can render the output 123 in the user interface and on the display 215. The user device 102 can store any particular pertinent data in a data store 217.

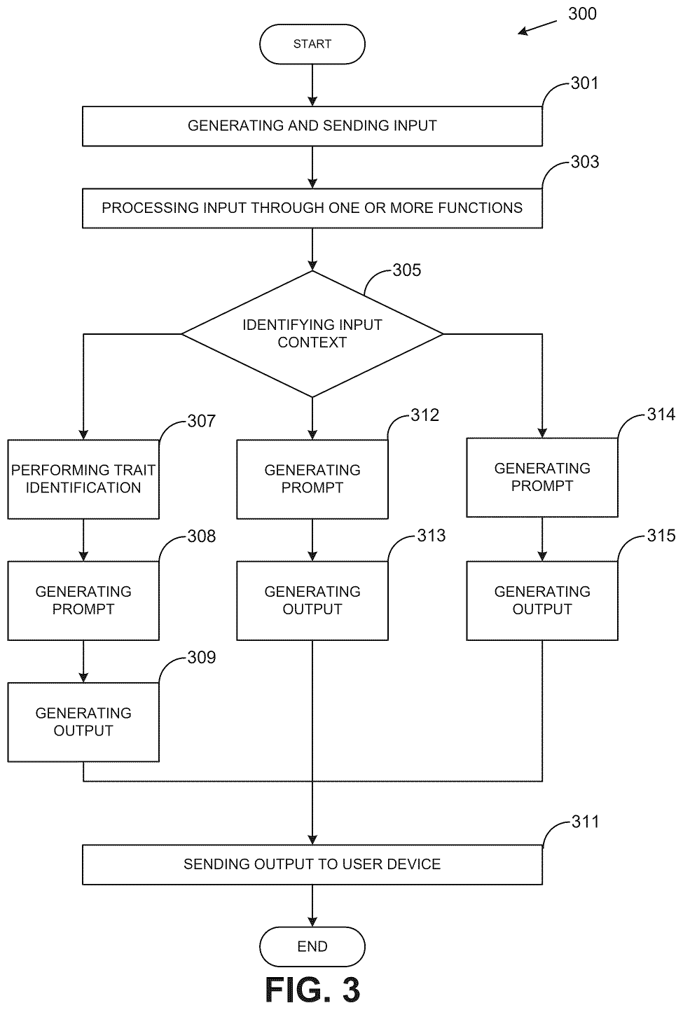

Referring now to FIG. 3, illustrated is a flowchart of a first process 300, according to one example of the disclosed technology. The first process 300 can illustrate a technique for generating outputs 123 through the business-general system 241 and/or the business-role system 243. Any particular system distributed across the networked environment 200 can perform the first process 300.

At box 301, the first process 300 can include generating and sending the input 121.

The user device 102 can generate and send the input 121 to the computing environment 101. For example, the user device 102 can receive one or more textual inputs through a keyboard. The management application 219 can receive through the user interface the input 121. The management application 219 can send the input 121 to the computing environment 101 for further processing. Though discussed in the context of a textual input, the input 121 can include any particular form of natural language. For example, the input 121 can include spoken language, visual language, and/or written language.

At box 303, the first process 300 can include processing the input 121 through one or more functions 247 of the management console 239. The computing environment 101 on receiving the input 121 can process the input 121 through the functions 247 of the management console 239. For example, the management console 239 can review the input 121 using the appropriateness checker to identify any potential sensitive and/or inappropriate material. The management console 239 can employ the interaction counter and summarizer to track conversations between the computing environment 101 and the user device 102 and generate summaries of the conversation to reduce computational strains of the computing environment 101. Once the input 121 has been processed by the functions 247, the management console 239 can send the input 121 to the processing console 237 for further processing.

At box 305, the first process 300 can include identifying a context of the input 121. The processing console 237 can identify the context of the input 121. For example, the processing console 237 can assess and categorize the input 121 by prompting the large language model to identify one or more contexts from the input 121. The processing console 237 can employ a context assessment prompt stored in the prompt data 233 that requests the large language model to categorize the input 121 based on its context. For example, the context assessment prompt can include but is not limited to a directive to assess the context of the input 121, the specific input 121, and a predefined set of categories that describe the possible contexts of the input 121, along with the definitions of each category. The processing console 237 through the large language model can categorize the input 121 into one of x predefined categories. The list of categories can vary over time and can be specific to a particular entity and/or workplace environment. The processing console 237 can store the inputs 121 in the data store 211 and organize the inputs into sub-storages based on the identified contexts and/or categories. Some example contexts can include but are not limited to a situation context, a follow-up context, and a casual context. The situation context can refer to workplace scenarios or hypothetical situations that the user device 102 presents through the input 121. The situation context can capture inputs 121 that describe a problem, ask for guidance on how to handle a scenario or seek advice on a variety of different workplace-related matters. The follow-up context can include inputs 121 that serve as a continuation of an existing conversation between the computing environment 101 and the user device 102. For example, the inputs 121 that fall under the follow-up context can be related to the antecedent inputs 121 and/or outputs 123 and often seek additional clarification, further information, or other extensions of the conversation. The casual—this covers any other type of interaction or input. Input classified as “casual” reflects non-structured engagement, such as small talk, informal questions, or comments unrelated to specific advice-seeking. On identifying the situation context, the first process 300 can proceed to box 307. On identifying the follow-up context, the first process 300 can proceed to box 313. On identifying the casual context, the first process 300 can proceed to box 315.

At box 307, the first process 300 can include performing trait identification. The processing console 237 can perform trait identification to determine one or more traits associated with the user of the user device 102 and/or an individual associated with the input 121. The processing console 237 can perform trait identification when it has determined that the input 121 falls under the situation context. The processing console 237 can receive the input 121 and user data from the analysis data 235. The user data can include any particular data pertaining to the individual of interest of the input 121. The processing console 237 can use a trait identification prompt from the prompt data 233 to prompt the large language model to identify and categorize the most relevant personality traits of the employee in relation to the specific situation described in the input 121.

The trait identification prompt can include a directive for trait identification generation. For example, the trait identification prompt can instruct the large language model employed by the processing console 237 to assess the employee's personality traits from data gathered and stored in the analysis data 235. Continuing this example, the large language model can assess the employee's personality traits in the context of the provided situation detailed in the input 121. The trait identification prompt can instruct the large language mode to identify the most pertinent traits, thereby focusing the situation analysis on traits that are more relevant to the situation described in the input 121.

When the business-general system 241 performs the first process 300, the trait identification prompt can include the employee's personality data. For example, the employee's personal data can include a list of traits with associated levels (e.g., “Threat Response: High”). The personal data can provide the processing console 237 with the necessary context for the large language model to understand the employee's behavioral tendencies and characteristics. For example, the processing console 237 can analyze a list of traits associated with an employee or person as it pertains to the situation described in the input 121. Continuing this example, the processing console 237 can select the most pertinent traits. On selecting the most pertinent traits, the processing console 237 through the large language model can output the traits in a structured format (e.g., Trait 1: Level,”“Trait 2: Level”).

When the business-role system 243 performs the first process 300, the trait identification prompt can include employee personality data with role-specific details. The trait identification prompt can operate using the employee's personality data stored in the analysis data 235, which can be formatted as a list of traits and their associated levels. Different from the business-general system 241, the business-role system 243 can include the impact of the trait's level on the role (e.g., “Threat Response: High”, “Impact: Positive”). For example, the processing console 237 can identify if the trait's associated level has a negative, moderate, or positive impact on the particular job role. In some other embodiments, the processing console 237 can generate a message to the user with one or more questions. Based on the inputs received from the user in response to the one or more questions, the processing console 237 can determine one or more traits associated with the user.

The trait identification prompt can include the input 121, which the processing console 237 can employ during the trait analysis process. By including the input 121, the processing console 237 can ensure that the identified traits are relevant to the specific context of the input 121.

The trait identification prompt can specify the required format of the output 123, directing the large language model of the processing console 237 to list the various identified traits and their associated levels. For example, the trait identification prompt can include information that states that the output 123 must be formatted in a uniform manner (e.g., “Trait 1: Level,”“Trait 2: Level,”etc.).

At box 308, the first process 300 can include generating a prompt. The processing console 237 can generate a prompt. The prompt can include a situation solution prompt, a follow-up prompt, a casual prompt, and any other prompt that can be provided to the large language model to generate the output 123. The prompt can include user data, which can include any data related to the user. For example, the user data can include data related to skills, education, or experience and can be generated by parsing the user's resume, cover letter, or other documents associated with the user. In some embodiments, the user data can be retrieved from the data store 211 or the data store 217. The prompt can be generated based on the prompt data 233. The prompt data 233 can include instructions for generating the prompt. The prompt can include the input 121 and the output from the trait identification prompt (e.g., the traits and the associated levels). The prompt can include instructions to generate the output 123 in a particular format. The prompt can include instructions to use the conversation history to generate the output. The prompt can include instructions for the LLM to assess the employee's personality traits on the context of the situation as described in the input 121. The prompt can include instructions to identify the most relevant traits based on the situation.

At box 309, the first process 300 can include generating the output 123. The processing console 237 can generate the output 123 based on the input 121, the identified traits, and/or any other data stored in the analysis data 235. The processing console 237 can employ a situation solution. to generate the output 123 in response to the input 121. The situation solution prompt can prompt the large language model to formulate a response that considers both the situational context and the employee's identified traits. The situation solution prompt can include a directive for situational analysis generation. The directive for situational analysis generation can request the large language model to reflect on the identified traits in the context of the described situation detailed in the input 121. The situation solution prompt can the identified traits. The situation solution prompt can include the input 121. The situation solution prompt can include response structuring guidelines. The response structuring guidelines can include a description on how the output 123 should be formatted by the large language model. For example, the response structuring guidelines can include directives to reflect on the situation detailed in the input, use relevant details from conversation history, and begin the response with a brief summary of the situation, providing an overview that frames the guidance clearly for the user. The processing console 237 can feed the situation solution prompt to the large language model to generate the output 123.

At box 311, the first process 300 can include sending the output 123 to the user device 102. The management console 239 can send the output 123 to the user device 102. The user device 102 can render the output 123 in the user interface of the management application 219 and on the display 215.

At box 312, the first process 300 can include generating a prompt. The processing console 237 can generate a prompt. The prompt can include a situation solution prompt, a follow-up prompt, a casual prompt, and any other prompt that can be provided to the large language model to generate the output 123. The prompt can include user data, which can include any data related to the user. For example, the user data can include data related to skills, education, or experience and can be generated by parsing the user's resume, cover letter, or other documents associated with the user. In some embodiments, the user data can be retrieved from the data store 211 or the data store 217. The prompt can be generated based on the prompt data 233. The prompt data 233 can include instructions for generating the prompt. The prompt can include the input 121 and the output from the trait identification prompt (e.g., the traits and the associated levels). The prompt can include instructions to generate the output 123 in a particular format. The prompt can include instructions to use the conversation history to generate the output. The prompt can include instructions for the LLM to maintain coherence in the output 123 (e.g., based the output 123 on the conversation history).

At box 313, the first process 300 can include generating the output 123. The processing console 237 can generate the output 123. The first process 300 can progress from box 305 to box 313 when the processing console 237 categorizes the context of the input 121 as the follow-up context. The processing console 237 can prompt the large language model to generate the output 123. For example, the processing console 237 can employ a follow-up prompt from the prompt data 233 to prompt the large language model to generate the output 123. The follow-up prompt can include a directive for follow-up response generation, the input 121, session history, and response structuring guidelines. The directive for follow-up response generation can include a description requesting the large language model to consider the conversational history to respond to the input 121. The processing console 237 can feed the follow-up prompt to the large language model to generate the output 123.

At box 314, the first process 300 can include generating a prompt. The processing console 237 can generate a prompt. The prompt can include a situation solution prompt, a follow-up prompt, a casual prompt, and any other prompt that can be provided to the large language model to generate the output 123. The prompt can include user data, which can include any data related to the user. For example, the user data can include data related to skills, education, or experience and can be generated by parsing the user's resume, cover letter, or other documents associated with the user. In some embodiments, the user data can be retrieved from the data store 211 or the data store 217. The prompt can be generated based on the prompt data 233. The prompt data 233 can include instructions for generating the prompt. The prompt can include the input 121 and the output from the trait identification prompt (e.g., the traits and the associated levels). The prompt can include instructions to generate the output 123 in a particular format. The prompt can include instructions to generate a casual output 123 (e.g., friendly, conversational) based on the input 121. The prompt can include instructions to redirect the user to workplace-relevant topics or workplace appropriate topics depending on the input 121 and one or more predefined rules (e.g., rules defining workplace relevant or appropriate topics).

At box 315, the first process 300 can include generating the output 123. The processing console 237 can generate the output 123. The first process 300 can progress from box 305 to box 315 when the processing console 237 determines that the context of the input 121 is the casual context. The processing console 237 can employ a casual prompt to prompt the large language model to generate the output 123 for the input 121. The casual prompt can include a directive for casual response generation, the input 121, response structuring guidelines, and context redirection. The directive for casual response generation can include a statement that directs the large language model to generate a casual output 123 in response to the input 121. The casual prompt can include the context redirection to prompt the large language model to generate the output 123 with a request to redirect the conversation back to workplace-relevant topics and situations.

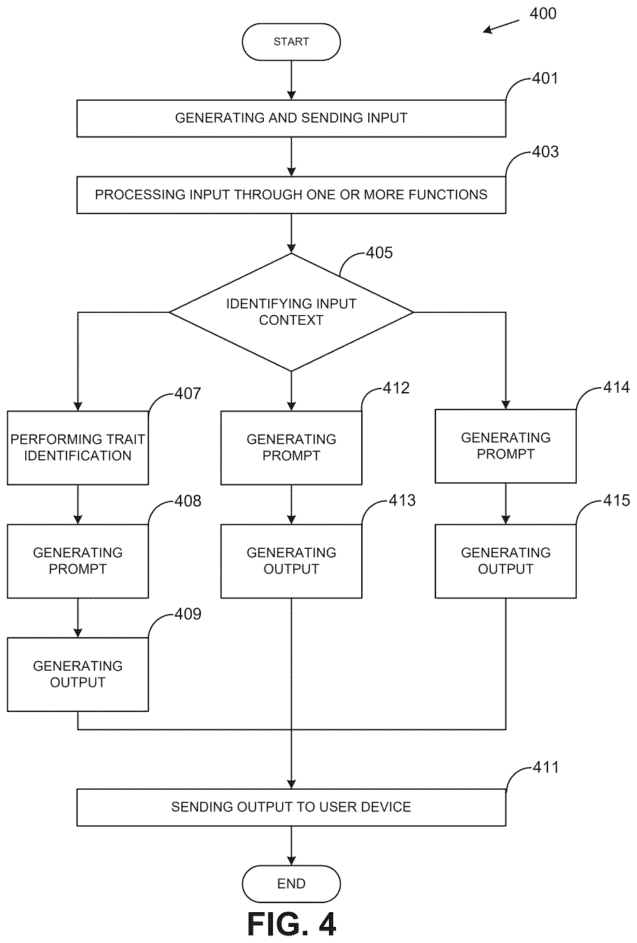

Referring now to FIG. 4, illustrated is a flowchart of a second process 400, according to one example of the disclosed technology. The second process 400 can illustrate a technique for generating outputs 123 through the self-discovery system 245. Any particular system distributed across the networked environment 200 can perform the second process 400.

At box 401, the second process 400 can include generating and sending the input 121. The user device 102 can generate and send the input 121 to the computing environment 101. For example, the user device 102 can receive one or more textual inputs through a keyboard. The management application 219 can receive through the user interface the input 121. The management application 219 can send the input 121 to the computing environment 101 for further processing. Though discussed in the context of a textual input, the input 121 can include any particular form of natural language. For example, the input 121 can include spoken language, visual language, and/or written language.

At box 403, the second process 400 can include processing the input 121 through one or more functions 247 of the management console 239. The computing environment 101 on receiving the input 121 can process the input 121 through the functions 247 of the management console 239. For example, the management console 239 can review the input 121 using the appropriateness checker to identify any potential sensitive and/or inappropriate material. The management console 239 can employ the interaction counter and summarizer to track conversations between the computing environment 101 and the user device 102 and generate summaries of the conversation to reduce computational strains of the computing environment 101. Once the input 121 has been processed by the functions 247, the management console 239 can send the input 121 to the processing console 237 for further processing.

At box 405, the second process 400 can include identifying a context of the input 121. The processing console 237 can identify the context of the input 121. For example, the processing console 237 can assess and categorize the input 121 by prompting the large language model to identify one or more contexts from the input 121. The processing console 237 can employ a context assessment prompt stored in the prompt data 233 that requests the large language model to categorize the input 121 based on its context. For example, the context assessment prompt can include but is not limited to a directive to assess the context of the input 121, the specific input 121, and a predefined set of categories that describe the possible contexts of the input 121, along with the definitions of each category. The processing console 237 through the large language model can categorize the input 121 into one of x predefined categories. The list of categories can vary over time and can be specific to a particular entity and/or workplace environment. The processing console 237 can store the inputs 121 in the data store 211 and organize the inputs into sub-storages based on the identified contexts and/or categories. Some example contexts can include but are not limited to a situation context, a self-reflection context, a development context, a follow-up context, and a casual context. The situation context can refer to workplace scenarios or hypothetical situations that the user device 102 presents through the input 121. The situation context can capture inputs 121 that describe a problem, ask for guidance on how to handle a scenario or seek advice on a variety of different workplace-related matters. The self-reflection context can include any input 121 that discusses personal introspection, where the user seeks to explore, analyze, or better understand their personality traits, behaviors, or decisions within professional and/or personal contexts. The development context can include inputs 121 that focus on inquiries about personal or professional growth, strategies for skill enhancement, and guidance for advancing one's career or self-improvement efforts. The follow-up context can include inputs 121 that serve as a continuation of an existing conversation between the computing environment 101 and the user device 102. For example, the inputs 121 that fall under the follow-up context can be related to the antecedent inputs 121 and/or outputs 123 and often seek additional clarification, further information, or other extensions of the conversation. The casual—this covers any other type of interaction or input. Input classified as “casual” reflects non-structured engagement, such as small talk, informal questions, or comments unrelated to specific advice-seeking. On identifying the situation context, the self-reflection context, and/or the development context, the second process 400 can proceed to box 407. On identifying the follow-up context, the second process 400 can proceed to box 413. On identifying the casual context, the second process 400 can proceed to box 415.

At box 407, the second process 400 can include performing trait identification. The processing console 237 can perform trait identification to determine one or more traits associated with the user of the user device 102 and/or an individual associated with the input 121. The processing console 237 can perform trait identification when it has determined that the input 121 falls under the situation context, the self-reflection context, and/or the development context. The processing console 237 can receive the input 121 and user data from the analysis data 235. The user data can include any particular data pertaining to the individual of interest of the input 121. The processing console 237 can use a trait identification prompt from the prompt data 233 to prompt the large language model to identify and categorize the most relevant personality traits of the employee in relation to the specific situation described in the input 121. The trait identification prompt can include but is not limited to a directive for trait identification, various personality data, the input 121, and response structuring guidelines. The directive for trait identification can include a statement requesting the large language model to extract one or more personality traits based on the personality data stored in the analysis data 235 and the input 121. The personality data included in the trait identification prompt can include any personal data gathered on the individual in question. The response structuring guideline can specify a particular output format. For example, the output format can include a list the identified traits and their levels in a structured format (e.g., “Trait 1: Level,”“Trait 2: Level”).

At box 408, the second process 400 can include generating a prompt. The processing console 237 can generate a prompt. The prompt can include a situation solution prompt, a follow-up prompt, a casual prompt, a self-reflection prompt, a development prompt, and any other prompt that can be provided to the large language model to generate the output 123. The prompt can include user data, which can include any data related to the user. For example, the user data can include data related to skills, education, or experience and can be generated by parsing the user's resume, cover letter, or other documents associated with the user. In some embodiments, the user data can be retrieved from the data store 211 or the data store 217. The prompt can be generated based on the prompt data 233. The prompt data 233 can include instructions for generating the prompt. The prompt can include the input 121 and the output from the trait identification prompt (e.g., the traits and the associated levels). The prompt can include instructions to generate the output 123 in a particular format. The prompt can include instructions to use the conversation history to generate the output. The prompt can include instructions for the LLM to assess the employee's personality traits on the context of the situation as described in the input 121. The prompt can include instructions to identify the most relevant traits based on the situation.

At box 409, the second process 400 can include generating the output 123. The processing console 237 through one or more large language models can generate the output 123. The processing console 237 can employ different prompts for generating the output 123 based on the identified context of the input 121. For example, the processing console 237 can employ a solution prompt to prompt the large language model to generate the output 123 for a particular input 121 originally identified as the solution context. The solution prompt can include a directive for insight analysis, incorporation of the identified traits, the input 121, and a response structuring guideline. The directive for insight analysis can include a statement to prompt the large language model to consider how the traits influence the user's behaviors, situations, or decision-making and to formulate a response that aligns with the user's personality.

In another example, the processing console 237 can employ a self-reflection response prompt from the prompt data 233 to generate a particular output 123. The self-reflection prompt can include a directive for self-reflection analysis generation, incorporation of the identified traits, the input, and a response structuring guideline. The directive for self-reflection analysis generation can include a statement to prompt the large language model to consider the identified traits concerning the user's reflective input 121.

In yet another example the processing console 237 can employ a development prompt from the prompt data 233 to generate a particular output 123. The development prompt can include a directive for development response generation, incorporation of the identified traits, the input, and a response structuring guideline. The directive for development response generation can include a statement to prompt the large language model assess the individual's personality traits in the context of the user's development-related input 121.

At box 411, the second process 400 can include sending the output 123 to the user device 102. The management console 239 can send the output 123 to the user device 102. The user device 102 can render the output 123 in the user interface of the management application 219 and on the display 215.

At box 412, the second process 400 can include generating a prompt. The processing console 237 can generate a prompt. The prompt can include a situation solution prompt, a follow-up prompt, a casual prompt, a self-reflection prompt, a development prompt, and any other prompt that can be provided to the large language model to generate the output 123. The prompt can include user data, which can include any data related to the user. For example, the user data can include data related to skills, education, or experience and can be generated by parsing the user's resume, cover letter, or other documents associated with the user. In some embodiments, the user data can be retrieved from the data store 211 or the data store 217. The prompt can be generated based on the prompt data 233. The prompt data 233 can include instructions for generating the prompt. The prompt can include the input 121 and the output from the trait identification prompt (e.g., the traits and the associated levels). The prompt can include instructions to generate the output 123 in a particular format. The prompt can include instructions to use the conversation history to generate the output. The prompt can include instructions for the LLM to assess the employee's personality traits on the context of the situation as described in the input 121. The prompt can include instructions to identify the most relevant traits based on the situation.

At box 413, the second process 400 can include generating the output 123. The processing console 237 can generate the output 123. The second process 400 can progress from box 405 to box 413 when the processing console 237 categorizes the context of the input 121 as the follow-up context. The processing console 237 can prompt the large language model to generate the output 123. For example, the processing console 237 can employ a follow-up prompt from the prompt data 233 to prompt the large language model to generate the output 123. The follow-up prompt can include a directive for follow-up response generation, the input 121, session history, and response structuring guidelines. The directive for follow-up response generation can include a description requesting the large language model to consider the conversational history to respond to the input 121. The processing console 237 can feed the follow-up prompt to the large language model to generate the output 123.

At box 414, the second process 400 can include generating a prompt. The processing console 237 can generate a prompt. The prompt can include a situation solution prompt, a follow-up prompt, a casual prompt, a self-reflection prompt, a development prompt, and any other prompt that can be provided to the large language model to generate the output 123. The prompt can include user data, which can include any data related to the user. For example, the user data can include data related to skills, education, or experience and can be generated by parsing the user's resume, cover letter, or other documents associated with the user. In some embodiments, the user data can be retrieved from the data store 211 or the data store 217. The prompt can be generated based on the prompt data 233. The prompt data 233 can include instructions for generating the prompt. The prompt can include the input 121 and the output from the trait identification prompt (e.g., the traits and the associated levels). The prompt can include instructions to generate the output 123 in a particular format. The prompt can include instructions to use the conversation history to generate the output. The prompt can include instructions for the LLM to assess the employee's personality traits on the context of the situation as described in the input 121. The prompt can include instructions to identify the most relevant traits based on the situation.

At box 415, the second process 400 can include generating the output 123. The processing console 237 can generate the output 123. The second process 400 can progress from box 405 to box 415 when the processing console 237 determines that the context of the input 121 is the casual context. The processing console 237 can employ a casual prompt to prompt the large language model to generate the output 123 for the input 121. The casual prompt can include a directive for casual response generation, the input 121, response structuring guidelines, and context redirection. The directive for casual response generation can include a statement that directs the large language model to generate a casual output 123 in response to the input 121. The casual prompt can include the context redirection to prompt the large language model to generate the output 123 with a request to redirect the conversation back to workplace-relevant topics and situations.

From the foregoing, it will be understood that various aspects of the processes described herein are software processes that execute on computer systems that form parts of the system. Accordingly, it will be understood that various examples of the system described herein are generally implemented as specially-configured computers, including various computer hardware components and, in many cases, significant additional features as compared to conventional or known computers, processes, or the like, as discussed in greater detail herein. Examples within the scope of the present disclosure also include computer-readable media for carrying or having computer-executable instructions or data structures stored thereon. Such computer-readable media can be any available media that can be accessed by a computer or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid-state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general-purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data that cause a general-purpose computer, special-purpose computer, or special-purpose processing device such as a mobile device processor to perform one specific function or a group of functions.

Those skilled in the art will understand the features and aspects of a suitable computing environment in which aspects of the disclosure may be implemented. Although not required, some of the examples of the claimed innovations may be described in the context of computer-executable instructions, such as program modules or engines, as described earlier, being executed by computers in networked environments. Such program modules are often reflected and illustrated by flow charts, sequence diagrams, example screen displays, and other techniques used by those skilled in the art to communicate how to make and use such computer program modules. Generally, program modules include routines, programs, functions, objects, components, data structures, and application programming interface (API) calls to other computers, whether local or remote, etc., that perform particular tasks or implement particular defined data types within the computer. Computer-executable instructions, associated data structures and/or schemas, and program modules represent examples of the program code for executing steps of the methods disclosed herein. The particular sequence of such executable instructions or associated data structures represents examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Examples of the claimed innovation are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An example system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language, or other input devices (not shown), such as a microphone, etc. These and other input devices are often connected to the processing unit through known electrical, optical, or wireless connections.

The computer that affects many aspects of the described processes will typically operate in a networked environment using logical connections to one or more remote computers or data sources, which are described further below. Remote computers may be another personal computer, a server, a router, a network PC, a peer device, or other common network nodes, and typically include many or all of the elements described above relative to the main computer system in which the innovations are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the innovation is connected to the local network through a network interface or adapter. When used in a WAN or WLAN networking environment, the computer may include a modem, a wireless link, or other mechanisms for establishing communications over the wide-area network, such as the Internet. In a networked environment, program modules depicted relative to the computer, or portions thereof, may be stored in a remote data storage device. It will be appreciated that the network connections described or shown as examples and other mechanisms of establishing communications over wide area networks or the Internet may be used.

While various aspects have been described in the context of a preferred example, additional aspects, features, and methodologies of the claimed innovations will be readily discernible from the description herein by those of ordinary skill in the art. Many examples and adaptations of the disclosure and claimed innovations other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed innovations. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed innovations. In addition, some steps may be carried out simultaneously, contemporaneously, or in synchronization with other steps.

Clause 1. A system, comprising: a memory device; and at least one computing device communicatively coupled to the memory device, the at least one computing device being configured to: receive at least one input associated with a user account; perform a comparison of the at least one input to one or more predefined input criteria; in response to the comparison, determine a response module from one or more response modules based on the user account; determine a context associated with the at least one input based on the response module; generate a prompt comprising the context and the at least one input; apply a large language model to the prompt to generate an output; and transmit the output to the user account.

Clause 2. The system of clause 1, wherein the at least one computing device is further configured to: increment a counter in response to receiving the at least one input.

Clause 3. The system of clause 2, wherein the at least one computing device is further configured to: determine the counter exceeds a predefined threshold; and generate a summary of the at least one input and the output.

Clause 4. The system of clause 1, wherein performing the comparison of the at least one input to the one or more predefined input criteria is configured to determine if the at least one input is appropriate based on the one or more predefined input criteria.

Clause 5. The system of clause 4, wherein the at least one computing device is further configured to: determine that the at least one input is inappropriate based on the comparison; and in response to determining that the at least one input is inappropriate, transmit the output, wherein the output comprises a predefined response.

Clause 6. The system of clause 5, wherein the predefined response comprises a request for a new input based on the one or more predefined criteria.

Clause 7. A method, comprising: receive, via one of one or more computing devices, at least one input associated with a user account; performing, via one of the one or more computing devices, a comparison of the at least one input to one or more predefined input criteria; in response to the comparison, determining, via one of the one or more computing devices, a response module from one or more response modules based on the user account; determining, via one of the one or more computing devices, a context associated with the at least one input based on the response module; generating, via one of the one or more computing devices, a prompt comprising the context and the at least one input; applying, via one of the one or more computing devices, a large language model to the prompt to generate an output; and transmitting, via one of the one or more computing devices, the output to the user account.

Clause 8. The method of clause 7, further comprising: generating, via one of the one or more computing devices, a trait prompt comprising instructions to determine one or more traits relevant to context and the at least one input.

Clause 9. The method of clause 8, wherein the trait prompt further comprises instructions to determine a score associated with each of the one or more traits.

Clause 10. The method of clause 8, wherein the one or more traits are determined based on the at least one input.

Clause 11. The method of clause 8, wherein the one or more traits are determined based on user data associated with the user account.

Clause 12. The method of clause 8, further comprising: applying, via one of the one or more computing devices, the large language model to the trait prompt to generate a trait output, wherein the prompt includes the trait output.

Clause 13. The method of clause 12, wherein the prompt comprises an instruction to generate the output based on the trait output.

Clause 14. The method of clause 8, further comprising: transmitting, via one of the one or more computing devices, one or more questions to the user account; and receiving, via one of the one or more computing devices, one or more responses, wherein the one or more traits are determined based on the one or more responses.

Clause 15. A non-transitory computer-readable medium embodying a program that, when executed by at least one computing device, cause the at least one computing device to: receive at least one input associated with a user account; perform a comparison of the at least one input to one or more predefined input criteria; in response to the comparison, determine a response module from one or more response modules based on the user account; determine a context associated with the at least one input based on the response module; generate a prompt comprising the context and the at least one input; apply a large language model to the prompt to generate an output; and transmit the output to the user account.

Clause 16. The non-transitory computer-readable medium of clause 15, wherein the output includes one or more questions based on the at least one input.

Clause 17. The non-transitory computer-readable medium of clause 15, wherein each of the one or more response modules is associated with one or more predefined contexts.

Clause 18. The non-transitory computer-readable medium of clause 15, wherein the prompt includes instructions to generate the output based on a historical inputs and outputs associated with the user account.

Clause 19. The non-transitory computer-readable medium of clause 15, wherein the prompt includes instructions to determine if a user associated with the user account meets one or more criteria based on one or more traits associated with the user account.

Clause 20. The non-transitory computer-readable medium of clause 15, wherein output comprises one or more recommendations based on the at least one input.

The examples were chosen and described in order to explain the principles of the claimed innovations and their practical application so as to enable others skilled in the art to utilize the innovations and various examples and with various modifications as are suited to the particular use contemplated. Alternative examples will become apparent to those skilled in the art to which the claimed innovations pertain without departing from their spirit and scope.

Accordingly, the scope of the claimed innovations is defined by the appended claims rather than the foregoing description and the examples described therein.

What is claimed is:

1. A system, comprising:
a memory device; and
at least one computing device communicatively coupled to the memory device, the at least one computing device being configured to:
receive at least one input associated with a user account;
perform a comparison of the at least one input to one or more predefined input criteria;
in response to the comparison, determine a response module from one or more response modules based on the user account;
determine a context associated with the at least one input based on the response module;
generate a prompt comprising the context and the at least one input;
apply a large language model to the prompt to generate an output; and
transmit the output to the user account.

2. The system of claim 1, wherein the at least one computing device is further configured to:
increment a counter in response to receiving the at least one input.

3. The system of claim 2, wherein the at least one computing device is further configured to:
determine the counter exceeds a predefined threshold; and
generate a summary of the at least one input and the output.

4. The system of claim 1, wherein performing the comparison of the at least one input to the one or more predefined input criteria is configured to determine if the at least one input is appropriate based on the one or more predefined input criteria.

5. The system of claim 4, wherein the at least one computing device is further configured to:
determine that the at least one input is inappropriate based on the comparison; and
in response to determining that the at least one input is inappropriate, transmit the output, wherein the output comprises a predefined response.

6. The system of claim 5, wherein the predefined response comprises a request for a new input based on the one or more predefined criteria.

7. A method, comprising:
receive, via one of one or more computing devices, at least one input associated with a user account;
performing, via one of the one or more computing devices, a comparison of the at least one input to one or more predefined input criteria;
in response to the comparison, determining, via one of the one or more computing devices, a response module from one or more response modules based on the user account;
determining, via one of the one or more computing devices, a context associated with the at least one input based on the response module;
generating, via one of the one or more computing devices, a prompt comprising the context and the at least one input;
applying, via one of the one or more computing devices, a large language model to the prompt to generate an output; and
transmitting, via one of the one or more computing devices, the output to the user account.

8. The method of claim 7, further comprising:
generating, via one of the one or more computing devices, a trait prompt comprising instructions to determine one or more traits relevant to context and the at least one input.

9. The method of claim 8, wherein the trait prompt further comprises instructions to determine a score associated with each of the one or more traits.

10. The method of claim 8, wherein the one or more traits are determined based on the at least one input.

11. The method of claim 8, wherein the one or more traits are determined based on user data associated with the user account.

12. The method of claim 8, further comprising:
applying, via one of the one or more computing devices, the large language model to the trait prompt to generate a trait output, wherein the prompt includes the trait output.

13. The method of claim 12, wherein the prompt comprises an instruction to generate the output based on the trait output.

14. The method of claim 8, further comprising:
transmitting, via one of the one or more computing devices, one or more questions to the user account; and
receiving, via one of the one or more computing devices, one or more responses, wherein the one or more traits are determined based on the one or more responses.

15. A non-transitory computer-readable medium embodying a program that, when executed by at least one computing device, cause the at least one computing device to:
receive at least one input associated with a user account;
perform a comparison of the at least one input to one or more predefined input criteria;
in response to the comparison, determine a response module from one or more response modules based on the user account;
determine a context associated with the at least one input based on the response module;
generate a prompt comprising the context and the at least one input;
apply a large language model to the prompt to generate an output; and
transmit the output to the user account.

16. The non-transitory computer-readable medium of claim 15, wherein the output includes one or more questions based on the at least one input.

17. The non-transitory computer-readable medium of claim 15, wherein each of the one or more response modules is associated with one or more predefined contexts.

18. The non-transitory computer-readable medium of claim 15, wherein the prompt includes instructions to generate the output based on a historical inputs and outputs associated with the user account.

19. The non-transitory computer-readable medium of claim 15, wherein the prompt includes instructions to determine if a user associated with the user account meets one or more criteria based on one or more traits associated with the user account.

20. The non-transitory computer-readable medium of claim 15, wherein output comprises one or more recommendations based on the at least one input.
